(19) United States
(12) Patent Application Publication
(10) Pub. No.: US 2023/0125509 A1
(43) Pub. Date: Apr. 27, 2023

(54) BAYESIAN ADAPTABLE DATA GATHERING FOR EDGE NODE PERFORMANCE PREDICTION

(71) Applicant: EMC IP Holding Company LLC, Hopkinton, MA (US)

(72) Inventors: Paulo Abelha Ferreira, Rio de Janeiro (BR); Pablo Nascimento da Silva, Rio de Janeiro (BR); Vinicius Michel Gottin, Rio de Janeiro (BR)

(21) Appl. No.: 17/451,780

(22) Filed: Oct. 21, 2021

(51) Int. Cl. G06N 7/00; H04L 12/751

(52) U.S. Cl. CPC G06N 7/005; H04L 45/02

(57) ABSTRACT

One example method includes performing, at a central node operable to communicate with edge nodes of an edge computing environment, operations that include signaling the edge nodes to share their respective data distributions to the central node, collecting the data distributions, performing a Bayesian clustering operation with respect to the edge nodes to define clusters that group some of the edge nodes, and one of the edge nodes in each cluster is a representative edge node of that cluster, and sampling data from the representative edge nodes.

### RELATED APPLICATIONS

This application is related to U.S. patent application Ser. No. 17/333,200, entitled Edge Data Distribution Cliques, and filed 2021 May 28 (the “'200 Application). The '200 Application is incorporated herein in its entirety by this reference.

### FIELD OF THE INVENTION

Embodiments of the present invention generally relate to the gathering of data for training and refining a machine learning model. More particularly, at least some embodiments of the invention relate to systems, hardware, software, computer-readable media, and methods for identifying particular nodes that are expected to serve as data nodes in place of a similar group so as to minimize the amount of data sent to a central node for effectively training a machine learning model.

### BACKGROUND

There are many cases where it would be useful to train a central Machine Learning (ML) model to be used for inference of data coming from different edge nodes. An example, but not limiting case, would be predicting the performance of storage arrays, the edge nodes in this example, to enable sizing new storage arrays for customers. Sizing is a crucial step when defining the right infrastructure to support customer needs. However, it is often done without knowing exactly if the sized infrastructure will satisfy the response time requirements of the end user applications. An ML model able to predict storage array response time may enable much better sizing applications.

One caveat when training a central ML model is that the edge nodes must keep sending new data to maintain a high accuracy, and fresh, model at the central node. Since the amount of data required from each node might be large, in order to reduce costs and improve customer experience, data sharing from customers should be minimized. A complicating factor is that there may also be non-strict anonymity issues with the availability of the data. Thus, a balance may need to be struck between minimizing the amount of data sent from edge nodes to a central node, while also maintaining, or improving, the accuracy of the central ML model.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses a probability distribution divergence, with an example for a given feature of two storage arrays.

FIG. 2 discloses operations for finding maximal cliques for storage array data distributions.

FIG. 3 discloses how maximal cliques can change if the graph changes, such as due to changes in storage array data distributions.

FIG. 4 discloses two examples of data collection from different cliques.

FIG. 5 discloses a method for a continuous protocol for model and data management.

FIG. 6 discloses collected distributions being sent from edge nodes to a central node.

FIG. 7 discloses an example algorithm for finding maximal cliques.

FIG. 8 discloses example operations implemented by the algorithm of FIG. 7.

FIG. 9 discloses further example operations of the algorithm of FIG. 7.

FIG. 10 discloses an example embodiment of a method employing a Bayesian approach for node selection and data sampling.

FIG. 11 discloses aspects of an example computing entity operable to perform any of the disclosed methods, processes, algorithms, and operations.

### DETAILED DESCRIPTION OF SOME EXAMPLE EMBODIMENTS

Embodiments of the present invention generally relate to the gathering of data for training and refining a machine learning model. More particularly, at least some embodiments of the invention relate to systems, hardware, software, computer-readable media, and methods for identifying particular nodes that are expected to serve as data node in place of a similar group so as to minimize the amount of data sent to a central node for effectively training a machine learning model..

In general, example embodiments of the invention may operate to find groups of edge nodes in a probabilistic manner, within a Bayesian framework. That is, embodiments may apply a flexible clustering algorithm that may enable efficient identification of good candidates for cluster assignments even for a large, and/or growing, number of edge nodes and their data distributions. In more detail, some example embodiments are directed to the implementation and use of a Bayesian clustering algorithm to identify node clusters from which data may be sampled that can be used to train and maintain an ML algorithm.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that an embodiment may provide a node clustering protocol that is flexible and able to accommodate changes to the number of clusters to be used for providing data to an ML model. An embodiment of the invention may accommodate changes to the number of nodes in one or more clusters. Various other advantageous aspects of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Some Problems and Considerations Relating to Example Embodiments

Various technical problems are known to exist with regard to conventional approaches to node clustering. Following is a more in-depth discussion of some of these problems. In terms of context, example embodiments of the invention may aim to optimize a trade-off between model quality and computational overheads imposed on the edge nodes by the data collection and preparation processes.

One known circumstance concerns the collecting of representative data from edge nodes in a dynamic environment in which nodes are added, removed, and replaced, and cluster sizes increase and decrease. Typically, data from all edge nodes are required to train a central model that will achieve reasonable accuracy for all edge nodes. However, this means that all edge nodes will perform the necessary collection and preparation processes, which incurs computational, or processing, costs. Furthermore, in dynamic environments, the distributions of the data at the edge nodes may change over time. Thus, any approach that relies on an assessment of the representativeness of the collected data to optimize the data collection process must also deal with possible changes in this assessment over time.

Another concern to be addressed by some example embodiments is the computational overhead typically incurred in the collection and processing of data. Particularly, the more data is collected by an edge node, the more costs associated to network traffic are incurred. This is a classic tension in distributed learning settings. Furthermore, the collection of the data itself may impose some computational overhead, if it is not part of the normal operating mode of the node. In the case of storage arrays, as in the present example use case, while the configuration of the system is likely known at all times, there may be operational states in which the characteristics of the workloads are not collected. Collecting these data for the sole purpose of transmitting it to a central node for model training represents a small, but potentially significant, computational cost. This problem may be aggravated by the need to prepare the data before transmitting it. In some domains, processes such as filling in missing values, aggregations, format conversions, cleaning, and others, may need to be performed at the edge node before the data can be transmitted to the central node. These processes also increase the computational overhead.

Model management and updating also presents a challenge. For example, in dynamic scenarios where more data is made available at the edge nodes over time , it may be necessary to update the ML model periodically. In the example of the sizing of storage arrays, the workloads and telemetry data will likely vary in each node over time. Further, one caveat when updating the central ML model is that the edge nodes must keep sending new data to maintain a high accuracy, fresh, model at the central node. This further aggravates the problems described above.

As noted earlier, the '200 Application proposed a protocol for smart data sharing according to the similarity in node data distribution for training a central model with data from a set of edge nodes. That protocol identifies common groups, or cliques, of edge nodes with similar data distribution and then chooses to sample data from only a subset of nodes, or a particular node, from each group. Finally, this protocol may adapt to the current validation metric used to evaluate the model.

A possible shortcoming, in some circumstances, with the proposed solution in the '200 Application is that the solution may select a set of clusters completely determined by the particular indexing of edge nodes, or a random permutation thereof. The clusters found may still be valid, but this approach may incur a limitation since it may not necessarily be the case that the indexing of the edge nodes correspond to the best possible similarity assignment. In fact, it may be expected, in some circumstances, that the indexing may be quite far from representing any special “order” of similarity among nodes. The protocol in the '200 Application was limited in this way at least in part to avoid having to perform the exponential algorithm to find the best possible clusters among all possible pairwise comparisons of node data. Another issue with that protocol was that constructing the clusters may have a worst-case complexity of O(N²).

### B. Overview

As noted, the '200 Application proposed a protocol for smart data sharing according to the similarity in node data distribution for training a central model with data from a set of edge nodes. That protocol had a clique-finding algorithm for finding nodes with similar data distributions in order to form similarity clusters. While that protocol is effective in some certain circumstances, it may have some limitations in other circumstances, namely, in that protocol, selected clusters may be completely determined by the particular indexing of edge nodes, or a random permutation thereof, and, constructing the clusters has a worst-case complexity of O(N²).

Some embodiments of the invention may improve upon the protocol of the '200 Application by, among other things, reinterpreting the cluster finding part as a probabilistic problem, and then introducing an application of a probabilistic algorithm. More concretely, embodiments of the invention may perform a non-parametric clustering in the space of distribution parameters of edge node data in order to find similarity clusters. Then, embodiments may be able to sample edge nodes for each cluster in worst-case O(N). This approach may enable an efficient, and flexible method for finding clusters whose data may be effectively employed in training and maintaining a central ML model.

More generally then, embodiments may operate to train and periodically update a central ML model that is to be used for inference of data coming from different edge nodes, examples of which may include sensors, and computing systems and devices, such as storage arrays for example, that may comprise hardware and/or software. Embodiments may address the problem of maximizing the model quality while minimizing the computational overhead imposed over the nodes for obtaining and transmitting the data. Without limiting the scope of the invention in any way, the explanation of example embodiments herein may be facilitated by the particular example of using the sizing of storage arrays as an example. Sizing of computing resources such as storage arrays may be an important step when defining the right infrastructure to support customers' needs. However, defining needed customer infrastructure is often performed without knowing exactly if the sized infrastructure will satisfy the response-time requirements of the end user applications.

Embodiments may leverage the availability of telemetry data from different system configurations and use Machine Learning to model the relationship between configuration parameters such as, for example, storage model, number of flash or spin disks, number/type of processors, and number of engines, characteristics of the workloads running on those systems such as, for example, the number of cache read/write hits/misses, type and number of IOs, and size of reads/writes (e.g., in MB), and measured response times. By doing this, embodiments may be able to predict read and write response times of a specific system configuration for a particular workload without having to run the workload on the sized system. As a result, customers may receive an immediate estimate of the response times of the system they are evaluating, while the business unit may potentially reduce operational costs associated with system performance evaluations.

In order to leverage data coming from all the storage arrays to train a central model, there may be a need for partial or complete access to the data coming from each storage array. The more available data, the higher the expectation may be with respect to the quality of predictions generated by the central ML model. However, more data means more network traffic, thus presenting a tension commonly occurring in distributed learning settings. Furthermore, there may be processing costs associated with the data collection and/or preparation processes before the can be transmitted to the central node.

Although techniques such as Federated Learning (FL) may tackle the problem of data privacy at the edge by communicating model gradients, performing Federated Learning in non-independent and identically distributed (i.i.d.) data settings is still an open problem. Moreover, even techniques such as FL do not necessarily solve the problem of choosing which nodes to sample information, that is, gradients, from. However, example embodiments may be extended to deal with techniques such as FL by adapting the distributions over data to be over gradients.

As discussed elsewhere herein in further detail, and with respect to the example of storage arrays, it is expected that some arrays might have a different data distribution than others, but it is also expected that some arrays might share similar data distributions. Additionally, embodiments may leverage methods of probability distribution comparisons and efficient algorithms to select subsets of arrays from which to ask for data from the central model.

One possible concern that may arise in certain circumstances with the proposed solution in the '200 Application is that such approach may select a set of clusters completely determined by the particular indexing of edge nodes. The clusters found are still valid, but this approach may incur a limitation since it may not necessarily be the case that the indexing of the edge nodes correspond to their expected similarity. In fact, it may be expected, in some cases, for the indexing to be quite far from representing any special “order” of similarity among nodes.

With the foregoing points in mind, embodiments of the invention may recast the problem of finding clusters of similar node data distributions as a probabilistic one. That is, such embodiments may apply a flexible clustering algorithm that allows efficient finding of good candidates for cluster assignments, even for a large number of edge nodes and their data distributions. The insight of seeing the problem in a probabilistic light may enable bypassing the exponential problem of pairwise comparisons by using an optimization process, such as a Bayesian process, that is able to find a very good cluster assignment. Thus, example embodiments may recast the edge nodes clustering in a probabilistic light. This approach may allow a robust and flexible method that may, in some circumstances, improve upon the approach set forth in the '200 Application.

### C. Background

Following is a discussion of various concepts that may be helpful in understanding aspects of some example embodiments of the invention. Such concepts may include, for example, feature importance, probability divergence, and graph cliques.

### C.1 Feature Importance

When training ML models, the data is usually divided into the input and the output. The input may comprise several different samples that have one or more ‘features.’ To illustrate, for a storage array domain, each sample may be collected telemetry data for a 5-minute window, and the features would be the configuration parameters such as storage model, number of flash or spin disks, and the number of engines, for example, characteristics of the workloads running on those systems such as the number of cache read/write hits/misses, and size of reads/writes in MB, for example, and measured read/write response times would be outputs.

After model training, there exist several techniques for deriving feature importance, which consists of an ordered list highlighting the most important features in terms of their contributions for predicting the output of the ML model. More concretely, after running one of such techniques, it might be determined that the ‘number of flash disks’ is a much more important feature for predicting read/write response times than the ‘number of engines.’ Note that this is only an example and that feature importance must be derived on a case-by-case basis, depending on the chosen data, model and optimization method. Some techniques for feature importance are able to output normalized scores for each feature, thus providing weights for the contribution of each feature to the prediction of the output.

### C.2 Probability Divergence

A probability distribution is, informally, a function that assigns a positive or zero score to each possible outcome of an event, discrete or continuous, with possibly infinitely many outcomes. For instance, the probability distribution for read/write response times values of storage arrays might be obtained by considering all the available data collected from different arrays—or the probability of the number of running applications in a 5-minute window. The first is an example of a continuous probability distribution, and the second is an example of a discrete probability distribution, that is, a probability distribution that is time-bounded.

Suppose, for example, that data has been collected for two storage arrays, regarding their respective number of running applications in a 5-minute window. The probability distribution could be calculated for each array which may lead to the question: how similar are these two probability distributions? This might shed light onto grouping these arrays as having some similarity, and also help understand the relationship between the arrays.

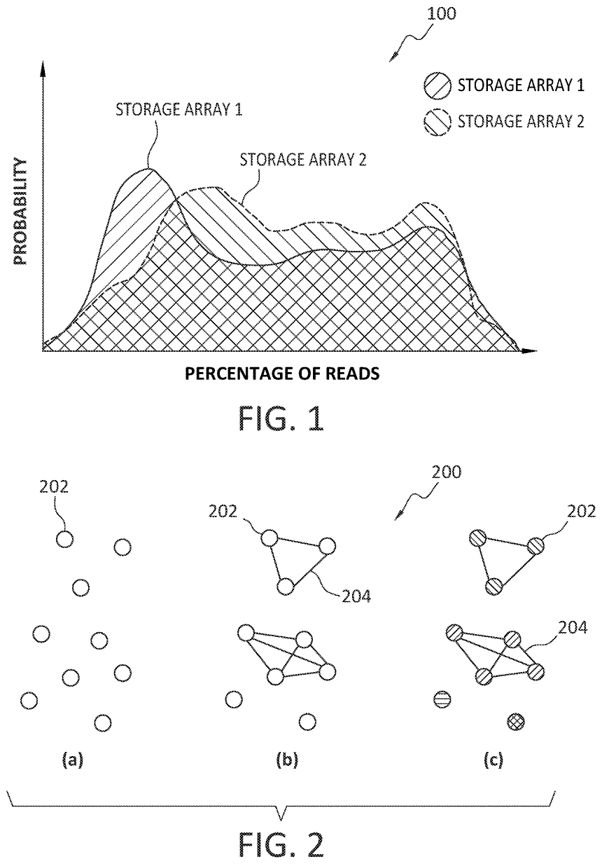

There are various ways to calculate divergence between probability distributions, depending on the goal and the distributions themselves. With attention now to the example of FIG. 1, there is disclosed a graph 100 showing a divergence in probability distribution between Storage Array 1 and Storage Array 2, where the feature of interest is the percentage of reads of the two storage arrays. Note that the number of reads is the number of times that a workload asks to read data, so that the percentage of reads is a ratio of the number of reads to the number of all IOs, which include both reads and writes, directed to that data. The read, or write, percentage may be measured for a discrete period of time.

Techniques for calculating distribution divergence can obtain a single number representing the “difference” or divergence between both distributions. Some of these techniques are bounded, for example, divergence between two numbers such as 0 and 1, and other techniques are symmetric, for example, the divergence from distribution A to B equals the divergence from distribution B to A.

### C.3 Graphs and Maximal Cliques

Graphs are powerful data structures able to model many different types of relationships. As used herein, a graph is a pair containing a set of vertices and a set of edges, where each edge joins exactly two vertices, and note that the set of vertices or edges may be empty. For instance, in one example use case, each vertex is a different respective storage array, and an edge exists between two nodes if two storage arrays share similar data distributions, that is, similar distributions of telemetry data such as IOs for example. Some explanation of data distributions may be helpful here.

Storage arrays may have various behaviors, and those may be shared by several storage arrays. For example, two storage arrays may have similar read/write patterns that comprise numerous IOs. Because the two storage arrays have similar read/write patterns, those storage arrays may be said to have similar data distributions. Thus, ‘data’ in this context refers not to actual data, but to the information about the read/write patterns, such as the number of IOs.

FIG. 2, discloses a concrete example 200 that starts (a) with a set of storage arrays and their data. Next, a discovery process is performed that discovers (b) which of the storage arrays share similar data distributions. Finally, the maximal cliques (c) may be found. In the example of FIG. 2, the storage arrays 202 are represented by nodes, edges 204 connecting two storage arrays 202 represent similarity, or low divergence, in the respective data distributions of the storage arrays 202, the different shading of some nodes 202 represents different cliques, that is, groups of arrays 202 that have similar data distributions. When the divergences from each array to another are calculated, a graph (c) may be produced, from which maximal cliques may be calculated.

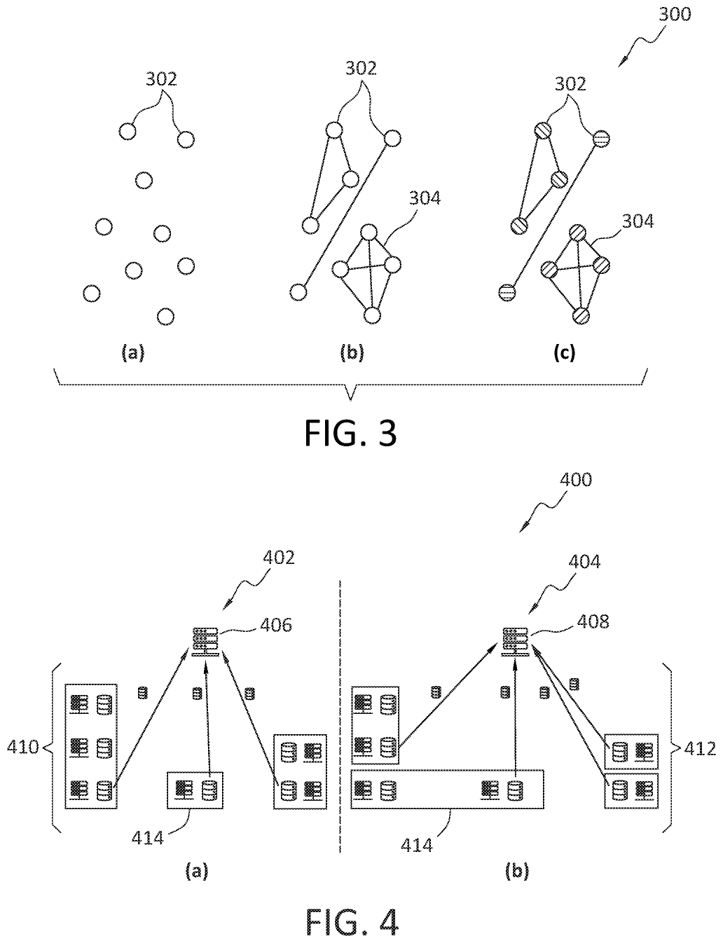

As shown in the example of FIG. 3, maximal cliques can change if the graph changes, because data distributions of the storage arrays have changed. The graphs 300 of storage arrays 302 (a) exemplified in FIG. 3 (b) and (c) is an undirected graph, that is, a graph whose edges 304 do not have directionality — rather, the edges 304 only indicate if a connection between nodes 302 exists or not. Therefore, it may be implicitly assumed that the similarity among distributions is symmetric: if storage array A has similar data distribution to storage array B, then the converse is also true, and storage array B has a similar data distribution to that of storage array A. For undirected graphs, reference may be made to the concept of a clique, which is a subset of vertices such that all vertices have an edge connecting them. This is represented by the nodes having different shading in FIG. 3 (c). In reality, the different shadings represent maximal cliques, that is, cliques that cannot be further expanded by including adjacent vertices.

In the concrete case, these maximal cliques, from groups where all storage arrays belonging to a same maximal clique, have similar data distributions—and storage arrays from different maximal cliques have dissimilar data distributions. Finding the ‘islands of similarity’ that group storage arrays' data distributions is the same problem as listing all maximal cliques in the graph. The best known algorithm for listing maximal cliques has a worst-case running time of O(3^{n/3}) [symbol] being the maximum number of maximal cliques in a group with ‘n’ vertices. However, better algorithms do exist in the case where the number of cliques is significantly smaller than the worst case, where it may be possible to achieve O(nm) per maximal clique, where n is the number of vertices; and m, the number of edges.

### C.4 Clustering Protocol for Edge Nodes Data Distributions

In this section, aspects of the '200 Application are reviewed in some detail in order to facilitate an understanding of aspects of example embodiments of the present invention. As noted earlier, the '200 Application refers to the training and updating of a central model leveraging data from several edge nodes. The protocol in the '200 Application may allow for many edge nodes to be considered without imposing computational costs on all of them at every data collection and evaluation cycle, all the while ensuring that enough representative data is collected to achieve a high-performance model across all nodes.

The approach in the '200 Application is to group the edge nodes into cliques such that only a representative node of the clique must incur the computational costs of collecting, preparing and transmitting the data. These cliques may change over time, informed by the collected data itself. Following is a description of a typical environment and proceed to discuss the steps in a cyclic protocol. The environment is represented in FIG. 4, with representative cliques of edge nodes highlighted. Particularly, the configuration 400 of FIG. 4 discloses two examples 402 and 404 of data collection from different cliques. In 402 and 404, a central node 406 and 408 are provided at the top, and edge nodes 410 and 412 at the bottom. Rectangles 414 represent edge nodes currently grouped under the same clique. One edge node, or more, from each clique may be selected to share data. At a certain point in time (a), edge nodes may be grouped together; and (b) this grouping might change if other cliques are found at a later point in time.

The '200 Application assumed an available central node with enough computational resources to hold the data collected by the edges and to perform the model training. In addition to the central node, allowance may be made for a variable number of edge nodes connected to the central node via some predetermined communication protocol or interface. Each edge node may comprise a distinct set of computational resources. The purpose of the method is to minimize the overhead imposed on those resources for the training of a central machine learning model. Notice that some, or all, edge nodes may comprise significant computational resources—still, because these nodes have their own workloads to process, any overhead imposed by the model training process is undesirable. In our example domain of storage arrays, it may be apparent that some storage arrays may comprise reasonably large compute, memory and network resources. Nonetheless, these resources are necessary for the operation of the storage array that owns them, and should ideally not be overly requisitioned by the training process. In fact, all that may be required of the edge nodes is that they have enough resources to compute probability distributions over the data they collect.

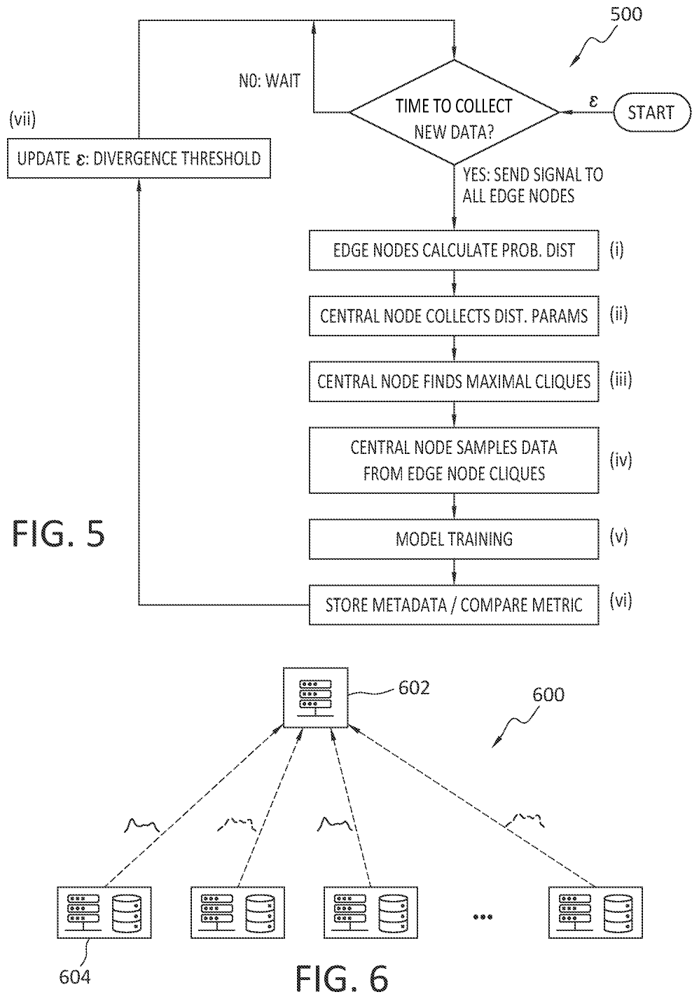

Next, a summary of the protocol of the '200 Application is presented, followed by a discussion of each step, with exemplary figures. Note that the protocol is composed of many cycles of data gathering, where at each cycle there is a sampling of a subset of the edge nodes for their data. FIG. 5 discloses a high-level flowchart 500 of the protocol.

In brief, the protocol has the following steps. Provided a value for the threshold ϵ, the method 500 periodically performs the following operations
i) Signal all nodes to start sharing their data distribution (a small set of parameters thereof) to the central node;
ii) Have the central node collect all distributions;
iii) At the central node, for each received distribution, the central node compares them using a bounded symmetric divergence metric (for example, the root square of the Jensen-Shannon divergence), optionally weighing these metrics by feature importance—a quasi-maximal clique finding algorithm may be applied to obtain clusters, or clique, of edge nodes sharing the “same” distribution, that is, distributions with a distance within the threshold ϵ;
iv) The central node selects one random element from each clique and sends a signalto this edge node to share its data;
v) After the data is received, a central mode is trained and kept as the new model, storing metadata for the training;
vi) Calculate and store the model metric to couple it to the next epsilon;
vii) Obtain ϵₜ₊₁=min (1, max(0 , ϵₜ−cθ))—this will bound epsilon to be between 0 and 1 so that any improvement or worsening of the model metric, might bring the model back to a different regime. This value becomes the new current threshold ϵ.

Each of the aforementioned operations of the example method 500 are now described in further detail. The method 500 starts with a provided threshold value ϵ. This value is used to determine, at each loop, how each pair of nodes relates with respect to the distribution of their data. The method starts with an arbitrary value for this threshold. The protocol will periodically send a signal to all edge nodes for the collection process to start. The periodicity of the protocol may be pre-defined. It is envisioned that an external process may determine the periodicity between iterations, perhaps even changing it over time. In the example domain considering storage arrays, this periodicity may be daily—with the process happening every day at a predetermined time in which the storage arrays are likely to be under a lighter load, as is typical for management tasks in deployed systems.

In operation (i) of the method 500, all nodes start sharing their data distribution, one per important feature, a small set of parameters thereof, to the central node. This may happen asynchronously—as some edge nodes may be more or less available at the time in which the signal is received. Furthermore, some edge nodes may even fail to respond to the request in reasonable time, or at all. It may be assumed that mechanisms for limiting the waiting time may defined as necessary, depending on the characteristics of the environment and of the domain. During this stage, the feature, or set of features, selected as the most representative and important features are used to calculate the data probability distribution of the data inside each edge node. Note that, at first all features are used to calculate the distributions, but the number of features is reduced during the process as detailed later. Then, these probability distributions are processed and are available to be sent to the central node.

A representative set of collected distributions for the edge nodes in an environment is shown in the configuration 600 of FIG. 6. Particularly, FIG. 6 indicates collected distributions being sent to a central node 602 from edge nodes 604. FIG. 6 also discloses the transmitted distributions being collected by the central node 602—in the operation (ii) of the method 500. The transmission costs of these distributions may be very low, since, in general, there is little to send back to the central node, simply the mean and variance of each feature - or any other parameter vector representing statistics, possibly sufficient, of the distribution. In some cases, when multimodal data is involved, it may be possible to send more than one value for mean and variance, which should increase the size of the sent package by a small amount. Note that the distributions of all available edge nodes are collected at each cycle. This is not a prohibitive cost, since each package sent is considerably small, possibly only a few KB.

In operation (iii) of the method 500, the central node leverages the collected distributions to determine the maximal cliques of nodes. This intuitively represents discovering which edge nodes share very similar data, so that there is only a need to sample a subset of the nodes for their data—and still be confident that the data is representative of the full set of nodes. This similarity is measured through the divergence between the distributions of data coming from each two nodes. For each received distribution, the central node compares them using a bounded symmetric divergence metric, such as Jensen-Shannon. It may be possible to use the square root of the Jensen-Shannon divergence that configures a metric and satisfies the properties of a distance metric. The final divergence can be calculated as the average divergence across all features being considered, and note that averaging will maintain distance metric properties.

The straightforward algorithm for finding the maximal cliques is exponential on the number of edge nodes, with a complexity of O(3^{n/3}). However, note that by considering a similarity within a reasonable threshold as equality, which holds the property of transitivity. Exploiting transitivity provides the ability to drastically reduce the complexityof the clique-finding algorithm.

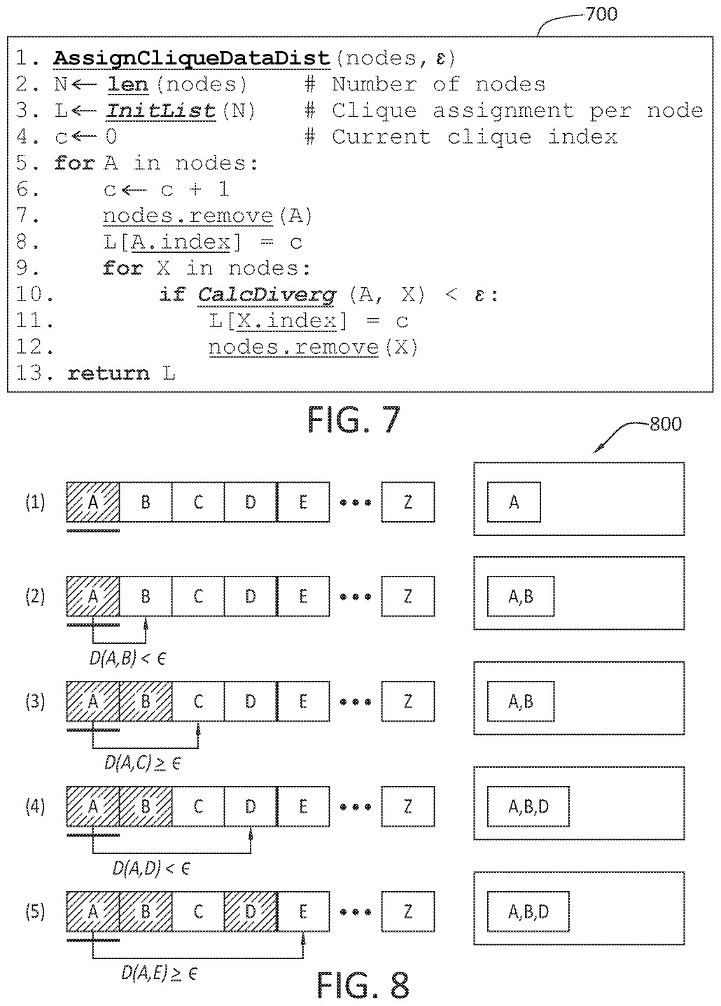

An example algorithm 700 disclosed in FIG. 7 comprises pseudocode for finding the maximal cliques. In general, the algorithm 700 may assign a clique to each node according to data distribution similarity. Particularly, given a list of all nodes, the nodes are processed one by one, and then removed from the list as they are processed. For each node A, the algorithm 700 iteratively computes the divergence D(A,X) between the node A and all nodes X, applying a threshold comparison to decide if they are similar. If the divergence is within a threshold ϵ, the compared nodes may be considered as equal and assigned the same clique.

With particular reference now to the lines of the algorithm 700, in lines 2 to 4, the algorithm 700 initializes the variables: N to store the number of nodes, L is a list of cliques and c is the current clique index. The main part of the algorithm is detailed in lines 5 to 12. In the outer ‘for’ loop, the algorithm 700 removes a node (node A) from the listof nodes and adds it to the list of cliques (lines 7 and 8). In the inner ‘for’ loop, the node removed from the list of nodes is compared against all remaining nodes in the list. If the divergence between two nodes (node A and node X), as calculated by CalcDiverg, is lower than the threshold ε, then the node X is added to the list of cliques related with thenode A. In the end of the process, the list L contains the clique index of each node. Nodeswith the same clique index belong to the same maximal cliques, and the number of unique indices in the list L is the number of maximal cliques found.

Note that by leveraging the transitive property of the equality, all further node comparisons may be skipped once a node is found to be equal to a previous node. This is exemplified in the scheme 800 of FIG. 8, which shows representative operations of the algorithm 700, with the list of nodes (left) as they are processed, and the divergence comparisons highlighted. The clique composed from the comparisons of all nodes to node A is shown on the right.

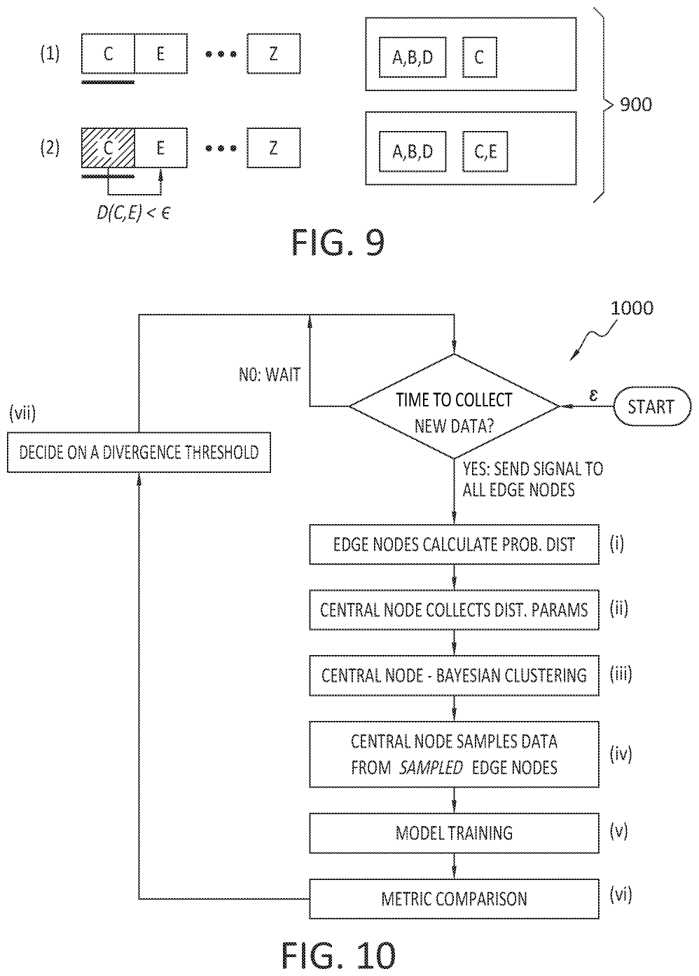

In these representative operations, a list of nodes A, B, C, D, E, . . . , Z is processed. The node A is selected, comprising an initial tentative clique by itself—and removed from the list, represented by a darkened background. The divergence between A and B is computed and found to be smaller than the threshold value. A and B are considered to be equal in distribution—and B is added to the clique, and removed from the list. In the following operation, the divergence between node A and C is computed, and found to be greater than the threshold. Hence, node C is skipped—it will be processed in a second iteration of the outer loop. Representative operations 900 of this possible second loop are shown in FIG. 9. Notice that in the second loop, nodes A, B, and D are not considered—as they comprise a clique that does not include C, as it has been ensured that the divergence of A and C is not within the threshold.

In the average case, the algorithmic complexity of the algorithm 700 is O(N²(N/M)), where M is the number of pairs of nodes that are similar with O(N)≤O(M)≤O((N²−N)/2) since each node is at least similar to itself, N=O(N), and there are at most (N²−N)/2=O(N²) pairs of nodes to be similar to each other. In the best case, no node diverges—they are all similar, M=(N²−N)/2 and the complexity is O(N). In the worst case, all nodes diverge, each comprises a clique of a unique node, M=N, and the complexity is O(N²).

A few considerations about the algorithm apply. The threshold value ε affects the definitions of similarity. In the extreme case ε<0, each node will be assigned a different clique; and if ε>1, all nodes will be assigned the same clique. Notice also that since a concept of similarity is being extended to represent equality, there may be edge cases in which the similarity between B and C is slightly above the threshold ϵ. However, by the triangle inequality property, if D(A, B)<ϵ and D(A, C)<ϵ then D(B, C)<2ϵ. Thus, it may be expected that for reasonable values of the threshold the added uncertainty is acceptable, given the favorable tradeoff in computational time provided by our algorithm.

Furthermore, because of the order of the processing of the nodes imposed by our algorithm, a node K, whose divergence D(B, K) is within the threshold may not be included in the same clique as B. This will be the case when B is processed prior to K,D(A, B)<ϵ and D(A, K) is just above the threshold e. An example can be seen in FIG. 7 regarding nodes B and E. Because B is processed before K and is found to be similar to A, it is removed from the list. No direct comparison between B and K will take place. Hence, the algorithm 700 may, in edge cases, result in cliques that are not maximal. The impact of generating non-maximal cliques is that more edge nodes will be required to acquire, transform, and send the data to the central node in the following steps. In any case, to minimize the impact of the ordering in the processing of the nodes, it is envisioned that an embodiment of the algorithm 700 will randomize the order of the nodes so that they are not evaluated in the same order at every iteration of the method. This will help ensure that a same node, such as node K in the example above, is not repeatedly penalized with being “excluded” from a clique.

In a typical embodiment of the '200 Application, CalcDiverg was assumed to be a straightforward implementation to obtain the square root of the Jensen-Shannon divergence between the distributions from the input nodes. Additional embodiments are envisioned in which CalcDiverg yields a difference metric weighted by an array of feature importance values. A feature value array may indicate which features are individually considered more or less important. Accounting for feature importance may be interesting to avoid having large divergences due to differences in unimportant features in two distributions. Conversely, even minute differences in important features should beenough to distinguish two nodes as belonging to different cliques. It may be assumed that the feature importance values are provided, either by a domain specialist or via some externalprocess. Alternatively, the feature importance values and may be obtained from the importance previously assigned to each feature by the model, as in the description of operation (v), below.

In the operation (iv), the central node uses the cliques to decide which node will send their data. The central node then samples a random subset, or a single, edge node to represent its clique and send data. Similarly, as in the collection of the distributions, mechanisms for accounting for excessive delay or unavailability of edge nodes may be defined based on the environment and the domain. A typical embodiment of such a mechanism would be to determine a maximum waiting time for the collection of the data from a representative node. If this time limit is exhausted and the data is not received, the central node may change its selection of the representative node for that clique.

Once enough data has been gathered, an ML model is trained in operation (v). This training happens in the central node. No particular ML algorithm is required. However, the process of finding the best set of features to build the data distribution may interfere in the choice of the feature selection algorithm. Algorithms like Random Forest internally produce a rank of the most relevant features, so no additional algorithm needs to be performed. In the case of selecting a machine learning algorithm that does not perform feature ranking, one should be able to use a feature selection algorithm such as Fisher Score, Information Gain, among others.

As a result of the training step a database of metadata and validation metric is obtained in operation (vi). The metadata is stored indexing the data used to train the model and the validation metric obtained. This metric is compared with the previous one obtained from last data batch and according to it a new threshold is defined (step (vii)) for the distribution similarity in order to:
1—try to obtain more diverse data to improve the model if the metric is doing worse; and
2—try to train the model obtaining less data if the model is doing well. After this, a new cycle of data gathering begins.
   As hyper-parameters of the protocol, there are the amount of data to be gathered, a maximum number of cycles, and the initial distribution divergence threshold. These must be defined on an application basis.

### D. Further Aspects of Some Example Embodiments

Attention is directed now to a more detailed discussion of aspects of some example embodiments of the invention. As noted earlier, example embodiments may create, and employ, a Bayesian framework for finding of groups of edge nodes. That is, example embodiments may approach the identification of such groups in a probabilistic manner. More specifically, example embodiments may implement and apply a flexible clustering algorithm which may efficiently find good candidates for cluster assignments even for a large, and/or growing, number of edge nodes and their data distributions. By approaching the challenge of cluster identification in a probabilistic light, embodiments of the invention may operate to bypass the exponential problem of pairwise comparisons by sticking with an optimization process, that is, a Bayesian process, that is able to find a very good, in a rigorous sense at least, cluster assignment for edge nodes.

With attention now to FIG. 10, a method 1000 is disclosed for a continuous protocol for model and data management. Except as noted herein, the method 1000 may be similar or identical to the method 500 disclosed in FIG. 5.

In the operation (iii) of the method 1000, embodiments may apply a flexible clustering algorithm for infinite mixture of infinite Gaussian mixtures, since such an approach may allow for a more flexible modeling of data sets with skewed and multi-modal cluster distributions. Prior to this Bayesian clustering process performed in (iii) however, the method 1000 may include, in operation (ii), the central node harvesting the distributions parameters from each edge node. The method 1000 may then, in operation (iii), discover the clusters, which intuitively represent similarity in the edge nodes data. With these clusters at hand, the method 1000 then advances and (iv) samples only a subset of the those edge nodes for their data. Thus, (iv) may be thought of as involving a sampling of a sampling, namely, a sampling of data, where the samples of data of are taken from a sample of edge nodes.

The similarity between nodes may be measured through the divergence between the distributions of data coming from each two nodes. In order to perform a clustering algorithm, it may be necessary to have a way to calculate the “distance,” or similarity, between the respective data distributions of two edge nodes. This distance calculation may be performed using any suitable approach, one example of which is a bounded symmetric divergence metric, such as Jensen-Shannon, for example. Some embodiments may employ the square root of the Jensen-Shannon divergence, which configures a metric and satisfies the required properties of a distance metric. The final divergence between two edge nodes may be calculated as the average divergence across all edge node features being considered. Note that averaging may be used to maintain distance metric properties.

Once a distance, or kernel, function has been defined, embodiments may employ a Bayesian clustering algorithm that has the Dirichlet prior over components starting from a uniform assumption and progressively being updated from the posterior of the clustering process. An algorithm that allows for different clusters to influence each other, that is, an algorithm that does not have the strict independence assumptions over cluster components, may be particularly useful in some circumstances. However, no particular clustering algorithm is required, and embodiments may employ any other Bayesian clustering algorithm that would also allow for dependence among cluster components and multimodality in the elements. Another useful aspect of using a Bayesian clustering algorithm is that the number of clusters can arbitrarily grow to accommodate new edge nodes. This may be a particularly useful feature in dynamic situations such as where the edge environment continues to grow and change over time. Bayesian clustering algorithms that are relatively insensitive to changes, such as removal of an edge node from an assigned group or cluster, so that the change does not materially alter the cluster parameters.

As noted earlier, the operation (iv) may comprise sampling an existing edge node from each cluster. This is where the choice of a Bayesian clustering algorithm may increase flexibility and robustness, relative to non-Bayesian approaches, since the method 1000 may sample a node may from the cluster, or may pick the most probable node. That is, by employing a probabilistic clustering process, example embodiments may provide for a relatively richer “cluster object” rather than simply a clique which, as noted, may comprise a list of edge nodes sharing similar data.

To select one or more nodes for collecting new data, embodiments may choose the node(s) with maximum probability, maximum a posteriori, at one or more clusters. Regardless of the particular node sampling method, embodiments may perform clustering in the space of distribution parameters. Hence, a particular sample might not correspond to an actual existing node. One approach to sampling that may be employed in example embodiments may comprise selecting the closest actual node, that is, closest in terms of its distribution parameters, to the sampled point, incurring in O(N) worst case complexity on the number of points, or nodes. An alternative sampling approach that may be employed in some embodiments, such as constructing a space-partitioning data structure, might accomplish average-casecomplexity of O(logN), with O(N) in the worst case, possibly at the cost of constructing and maintaining the space-partitioning data structure.

### E. Further Discussion

As disclosed herein, example embodiments may provide various useful features and functionalities. One such example embodiment comprises an application of a Bayesian clustering algorithm that enables a more flexible and efficient, but still robust, node selection protocol. Such embodiments are flexible in that they may provide a much richer node clustering than may be provided by approaches that employ a clique algorithm for node clustering. Particularly, in example embodiments, each edge node may be assigned a probability of belonging to a given cluster, and the clusters themselves may also be assigned probabilities. Further, example embodiments may maintain robustness insofar as the number of clusters may arbitrarily grow to accommodate new edge nodes. Finally, example embodiments may be relatively more efficient, as compared with n on Bayesian approaches, insofar as such example embodiments may: (1) find the cluster through an optimization process which is not computationally prohibitive for a central node; and (2) may rely on sampling algorithms that run linearly on the number of cluster instances and nodes, thus improving the O(N²) bound relative to other approaches.

### F. Aspects of Example Methods

It is noted with respect to the example methods disclosed herein that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### G. Further Example Embodiments

Following are some further example embodiments of the invention. These are presented only by way of example and are not intended to limit the scope of the invention in any way.

Embodiment 1. A method, comprising: performing, at a central node operable to communicate with edge nodes of an edge computing environment, operations comprising: signaling the edge nodes to share their respective data distributions to the central node; collecting the data distributions; performing a Bayesian clustering operation with respect to the edge nodes to define clusters that group some of the edge nodes, and one of the edge nodes in each cluster is a representative edge node of that cluster; and sampling data from the edge nodes that are included in the cluster.

Embodiment 2. The method as recited in embodiment 1, wherein each data distribution comprises information concerning a configuration and/or operation of the edge node to which the data distribution corresponds.

Embodiment 3. The method as recited in any of embodiments 1-2, wherein another iteration of the Bayesian clustering operation is performed in response to a change to one of the clusters.

Embodiment 4. The method as recited in any of embodiments 1-3, wherein one or more of the edge nodes comprises a respective computing system, computing device, and/or software.

Embodiment 5. The method as recited in any of embodiments 1-4, wherein the Bayesian clustering [symbol] operates to add an edge node to one of the clusters based on a similarity of that edge node to one or more of the edge nodes in that cluster.

Embodiment 6. The method as recited in embodiment 5, wherein the similarity is a function of a distance between a data distribution of the edge node and the respective data distributions of one or more of the edge nodes in one of the clusters.

Embodiment 7. The method as recited in any of embodiments 1-6, wherein the cluster is updated automatically in response to addition of an edge node to the edge computing environment.

Embodiment 8. The method as recited in any of embodiments 1-7, wherein the operations further comprise defining an additional cluster in response to addition of new edge nodes to the edge computing environment.

Embodiment 9. The method as recited in any of embodiments 1-8, wherein assignment of one of the edge nodes to one of the clusters is based in part on a data probability distribution for that edge node.

Embodiment 10. The method as recited in any of embodiments 1-9, wherein the operations further comprise training a machine learning model using data sampled from the edge nodes that are included in the cluster.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

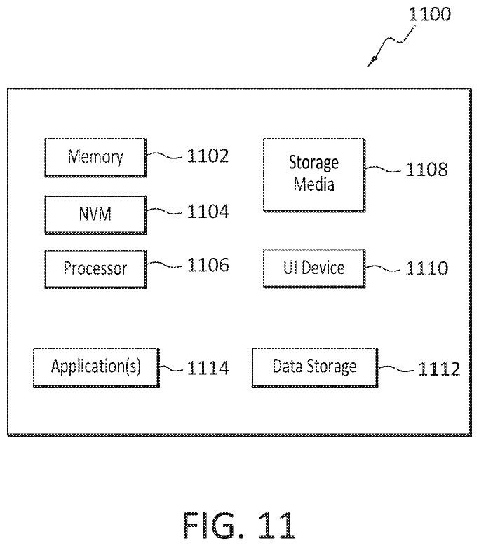

With reference briefly now to FIG. 11, any one or more of the entities disclosed, or implied, by FIGS. 1-10 and/or elsewhere herein, may take the form of, or include, or be implemented on, or hosted by, a physical computing device, one example of which is denoted at 1100. As well, where any of the aforementioned elements comprise or consist of a virtual machine (VM), that VM may constitute a virtualization of any combination of the physical components disclosed in FIG. 11.

In the example of FIG. 11, the physical computing device 1100 includes a memory 1102 which may include one, some, or all, of random access memory (RAM), non-volatile memory (NVM) 1104 such as NVRAM for example, read-only memory (ROM), and persistent memory, one or more hardware processors 1106, non-transitory storage media 1108, UI device 1110, and data storage 1112. One or more of the memory components 1102 of the physical computing device 1100 may take the form of solid state device (SSD) storage. As well, one or more applications 1114 may be provided that comprise instructions executable by one or more hardware processors 1106 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
performing, at a central node operable to communicate with edge nodes of an edge computing environment, operations comprising:
signaling the edge nodes to share their respective data distributions to the central node;
collecting the data distributions;
performing a Bayesian clustering operation with respect to the edge nodes to define clusters that group some of the edge nodes, and one of the edge nodes in each cluster is a representative edge node of that cluster; and
sampling data from the representative edge nodes.

2. The method as recited in claim 1, wherein each data distribution comprises information concerning a configuration and/or operation of the edge node to which the data distribution corresponds.

3. The method as recited in claim 1, wherein another iteration of the Bayesian clustering operation is performed in response to a change to one of the clusters.

4. The method as recited in claim 1, wherein one or more of the edge nodes comprises a respective computing system, computing device, and/or software.

5. The method as recited in claim 1, wherein the Bayesian clustering [symbol] operates to add an edge node to one of the clusters based on a similarity of that edge node to one or more of the edge nodes in that cluster.

6. The method as recited in claim 5, wherein the similarity is a function of a distance between a data distribution of the edge node and the respective data distributions of one or more of the edge nodes in one of the clusters.

7. The method as recited in claim 1, wherein the cluster is updated automatically in response to addition of an edge node to the edge computing environment.

8. The method as recited in claim 1, wherein the operations further comprise defining an additional cluster in response to addition of new edge nodes to the edge computing environment.

9. The method as recited in claim 1, wherein assignment of one of the edge nodes to one of the clusters is based in part on a data probability distribution for that edge node.

10. The method as recited in claim 1, wherein the operations further comprise training a machine learning model using data sampled from the edge nodes that are included in the cluster.

11. A computer readable storage medium having stored therein instructions that are executable by one or more hardware processors to:
perform, at a central node operable to communicate with edge nodes of an edge computing environment, operations comprising:
signaling the edge nodes to share their respective data distributions to the central node;
collecting the data distributions;
performing a Bayesian clustering operation with respect to the edge nodes to define clusters that group some of the edge nodes, and one of the edge nodes in each cluster is a representative edge node of that cluster; and
sampling data from the edge nodes that are included in the cluster.

12. The computer readable storage medium as recited in claim 11, wherein each data distribution comprises information concerning a configuration and/or operation of the edge node to which the data distribution corresponds.

13. The computer readable storage medium as recited in claim 11, wherein another iteration of the Bayesian clustering operation is performed in response to a change to one of the clusters.

14. The computer readable storage medium as recited in claim 11, wherein one or more of the edge nodes comprises a respective computing system, computing device, and/or software.

15. The computer readable storage medium as recited in claim 11, wherein the Bayesian clustering [symbol] operates to add an edge node to one of the clusters based on a similarity of that edge node to one or more of the edge nodes in that cluster.

16. The computer readable storage medium as recited in claim 15, wherein the similarity is a function of a distance between a data distribution of the edge node and the respective data distributions of one or more of the edge nodes in one of the clusters.

17. The computer readable storage medium as recited in claim 11, wherein the cluster is updated automatically in response to addition of an edge node to the edge computing environment.

18. The computer readable storage medium as recited in claim 11, wherein the operations further comprise defining an additional cluster in response to addition of new edge nodes to the edge computing environment.

19. The computer readable storage medium as recited in claim 11, wherein assignment of one of the edge nodes to one of the clusters is based in part on a data probability distribution for that edge node.

20. The computer readable storage medium as recited in claim 11, wherein the operations further comprise training a machine learning model using data sampled from the edge nodes that are included in the cluster.
